(19) United States
(12) Patent Application Publication
(10) Pub. No.: US 2007/0153825 A1
(43) Pub. Date: Jul. 5, 2007

(54) Streaming service providing method adaptive to dynamic network changes

(75) Inventors: Dae-woo Cho, Seoul (KR); Jong-won Kim, Gwangju (KR); Yoo-seung Hwang, Seoul (KR); Hyun-yong Lee, Gwangju (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/593,594

(22) Filed: Nov. 7, 2006

(30) Foreign Application Priority Data
Jan. 5, 2006 (KR) 10-2006-0001490

(51) Int. Cl. H04J 3/22

(52) U.S. Cl. 370/465; 370/252

(57) ABSTRACT

A streaming service providing method adaptive to dynamic network changes is provided. The streaming service providing method includes requesting a quality of service (QoS) adapter to provide adaptive services if a QoS manager, which allocates network resources among QoS devices processing media streams, does not accept a request to provide the adaptive services, wherein the QoS adapter determines a level of the adaptive services supportable by a network; and providing the adaptive services to the network.

### CROSS-REFERENCE TO RELATED APPLICATIONS

This application claims priority from Korean Patent Application No. 10-2006-0001490, filed on Jan. 5, 2006, the entire contents of which are incorporated herein by reference.

### BACKGROUND OF THE INVENTION

1. Field of the invention

The present invention relates to a streaming service providing method adaptive to dynamic network changes, and more particularly, to a streaming service providing method adaptive to dynamic network changes in a home network based on the Universal Plug and Play (UPnP) Quality of Service (QoS) architecture proposed by the UPnP QoS group under the UPnP forum.

2. Description of the Related Art

The UPnP QoS architecture has been proposed to share contents the QoS of which is guaranteed in a home network, which allocates a specific amount of network bandwidth for traffic streams, and suppresses allocating more bandwidth than a bandwidth a network can afford, thereby providing stream transmissions whose quality is guaranteed.

The a UPnP QoS architecture version 1.0 defines a scheme on an initial media service request acceptance. Further, as for the UPnP QoS architecture version 2.0, a scheme is being discussed which can monitor a dynamic network status, such as a QoS monitor, but the UpnP QoS architecture version 2.0 is not fixed yet. Further, the UPnP QoS architecture version 2.0 does not propose the scheme for utilizing collected information, and only defines simple service acceptance control functions.

Such UPnP QoS architecture versions 1.0 and 2.0 cannot manage network resources that do not comply with the UPnP QoS architecture. In other words, it is required for traffic stream transmissions whose quality is guaranteed to know the amounts of the network resources allocated for traffic streams and the network resources substantially used for traffic stream transmissions after the allocation. However, the UPnP QoS architecture versions 1.0 and 2.0 do not propose the schemes enabling dynamic network changes to be monitored. Therefore, it is impossible for networks incompliant with the UPnP QoS architecture to provide services since network resources environment cannot be checked out.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a streaming service providing method adaptive to dynamic network changes by overcoming limitations of the UPnP QoS architecture versions 1.0 and 2.0 based on the UPnP QoS architecture in a home network, thereby providing streaming services the quality of which is guaranteed.

According to an aspect of the present invention, there is provided a streaming service providing method, comprising requesting a QoS adapter to accept adaptive services if the services are not accepted which are requested to the QoS manager allocating network resources among QoS devices processing media streams wherein the QoS adapter determines a level of the services supportable to a certain network; and providing the services adaptive to the network.

The requesting a QoS adapter to accept adaptive services may include receiving resource environment information from a status monitor monitoring the network resources environment information, if there is a request for the network resources environment information; and sending the resource environment information to the QoS adapter and requesting for the adaptive services.

The requesting a QoS adapter to accept adaptive services may include requesting the adaptive services by a control point defining performance of contents transmissions of the network, if it is decided that the network resources environment affects service being currently provided; receiving the resources environment information from the status monitor monitoring the network resources environment information; and sending the resources environment information to the QoS adapter and requesting for the adaptive services.

The providing the services adaptive to the network may include determining a level of the adaptive services depending on the resource environment information; allocating resources for supporting the level of the adaptive services; and providing the adaptive services depending on the allocated resources.

While the streaming services are provided from a UpnP media server to a UPnP media renderer, the status monitor monitors network environments of the UPnP media server and the UPnP media renderer, and, if the status monitor detects resources changes to an extent that the streaming services are affected, requests the QoS adapter for the adaptive services.

Further, the resource environment information is bandwidth status information available in the network.

Further, the determining a level of the adaptive services depending on the resource environment information may include adjusting a transmission rate depending on the bandwidth status information.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a view illustrating a UPnP QoS architecture according to an exemplary embodiment of the present invention;

FIG. 2 is a view illustrating a protocol stack for streaming services of the UPnP QoS architecture according to an exemplary embodiment of the present invention;

FIGS. 3 and 4 are views illustrating a process for providing streaming services based on the UPnP QoS architecture according to an exemplary embodiment of the present invention;

FIG. 5 is a flow chart illustrating a streaming service providing method adaptive to the UPnP QoS architecture according to an exemplary embodiment of the present invention; and

FIGS. 6 to 8 are flow charts illustrating in detail a streaming service providing method adaptive to the UPnP QoS architecture of FIG. 5.

### DETAILED DESCRIPTION OF THE EXEMPLARY EMBODIMENTS

Hereinafter, exemplary embodiments of the present invention will be described in detail with reference to the accompanying drawings.

FIG. 1 is a view illustrating the UPnP QoS architecture according to an exemplary embodiment of the present invention.

In FIG. 1, the UPnP QoS architecture of the present invention includes a QoS policy holder 110 for setting and managing policy values to be used in a network to which the architecture itself belongs according to a command of a user 100, a control point 120 for requesting preparations for transmissions of contents whose QoS is guaranteed, and a QoS manager 130 for controlling acceptances of media streams among QoS devices 140, 150, and 160, performing network bandwidth allocations, and managing bandwidth resources of the network to which the architecture itself belongs.

The QoS manager 130 communicates with the QoS policy holder 110, and requests that a QoS-related policy value be applied to media streams. The QoS policy holder 110 determines the priority of the media streams based on the set policy values and sends the priority to the QoS manager 130, and the QoS devices 140, 150, and 160 process the media streams according to the policy values sent through the QoS manager 130.

The control point 120 has a traffic specification (Tspec) defining contents providers, receivers, contents to be sent, and performance characteristics required for contents transmissions. Such a control point 120 sends the Tspec to the QoS manager 130 to request for preparations for transmissions of contents whose QoS is guaranteed. Then, the QoS manager 130 requests the QoS policy holder 110 for an appropriate policy value based on the Tspec.

The information delivered through the Tspec contains a traffic class, Internet Protocol (IP) addresses of a contents provider and a receiver, and a protocol to be used. The Tspec information is sent to the QoS policy holder 110 through the QoS manager whenever there is a QoS preparation request for contents transmissions. At this point, the QoS policy holder 110 reviews the sent Tspec information, and returns an appropriate policy value to be applied to traffic streams.

Further, in order to guarantee the quality of the contents traffic to be sent to a required level, the QoS manager 130 takes an appropriate action on the QoS devices 140, 150, and 160 based on the policy value obtained from the QoS policy holder 110. Accordingly, traffic streams are sent the QoS device 140, which is a source, to the QoS device 160, which is a sink, through the QoS device 150, which is an intermediate means.

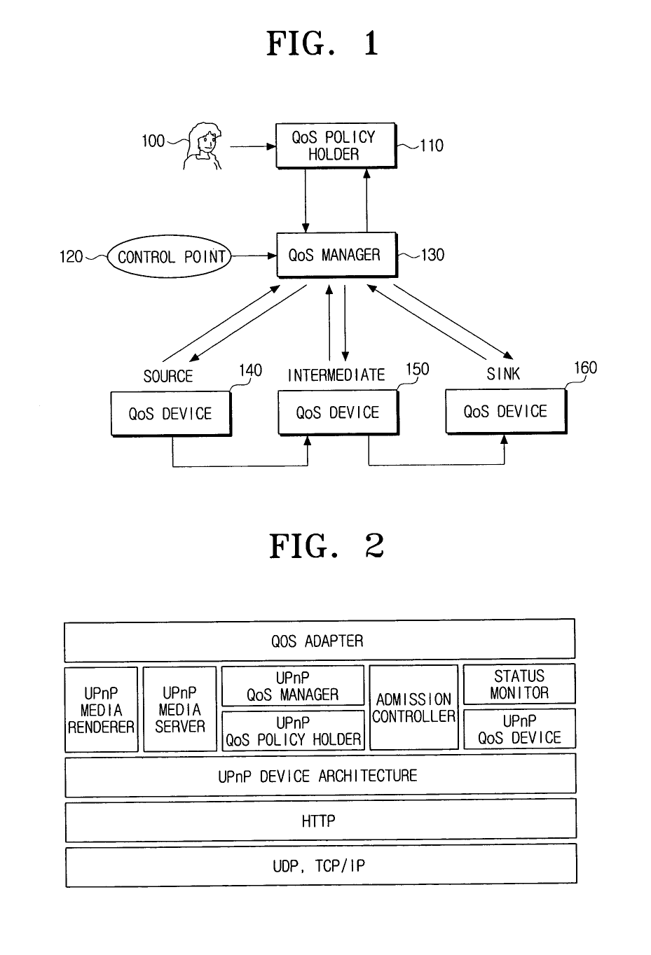

FIG. 2 is a view illustrating a protocol stack for streaming services of the UPnP QoS architecture according to an exemplary embodiment of the present invention.

In FIG. 2, the UPnP media renderer is a media player for playing media back, and the UPnP media server is a media server for providing the media. The UPnP device architecture defines basic operations needed for UPnP networking such as addressing, discovering, description, control, eventing, and presentation.

The protocol stack according to an exemplary embodiment of the present invention includes a QoS adapter, admission controller, and status monitor. The QoS adapter determines a level of supportable services based on the current network resources. The admission controller requests the QoS adapter to provide adaptive services based on available network resources according to a request of the control point or the status monitor.

The status monitor monitors the network environment of the UPnP media server and the UPnP media renderer while streaming services are provided from the UPnP media server to the UPnP media renderer. At this time, if the status monitor detects resources changes that will affect the streaming services, it requests the QoS adapter to provide an adaptive service.

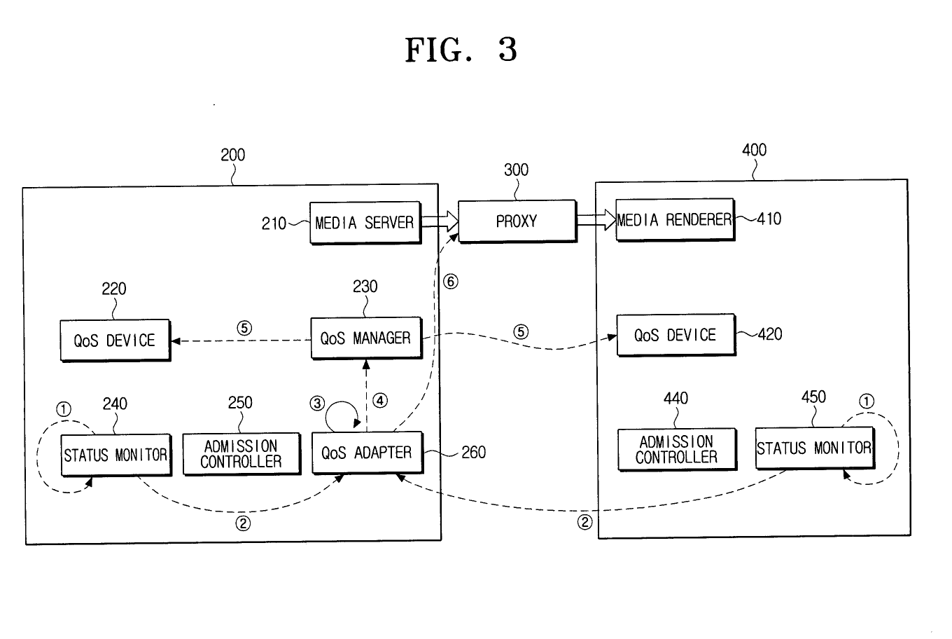

FIG. 3 shows a process for providing streaming services adaptive to network environment changes according to the protocol stack proposed in FIG. 2.

In FIG. 3, a status monitor 240 on the side of a media transmitter 200 and a status monitor 450 on a side of a media receiver 400 monitor the resources environment of the networks to which the status monitors 240 and 450 belong, respectively \textcircled{1}. Then, if the status monitors 240 and 450 detect resources changes to an extent that streaming services will be affected, the status monitors 240 and 450 request a QoS adapter 260 to provide an adaptive service \textcircled{2}.

The QoS adapter 260 determines a service level regarding the adaptive service request received from the status monitors 240 and 450 \textcircled{3}. Next, the QoS adapter 260 requests a QoS manager 230 to provide resources re-allocation \textcircled{4}, and the QoS manager 230 reallocates resources to a QoS device 220 on the side of the media transmitter 200 and a QoS device 420 on the side of the media receiver 400 \textcircled{5}. By doing so, the adaptive services start, and adapted streams are sent from a media server 210 to a media renderer 410 through a proxy 300 \textcircled{6}.

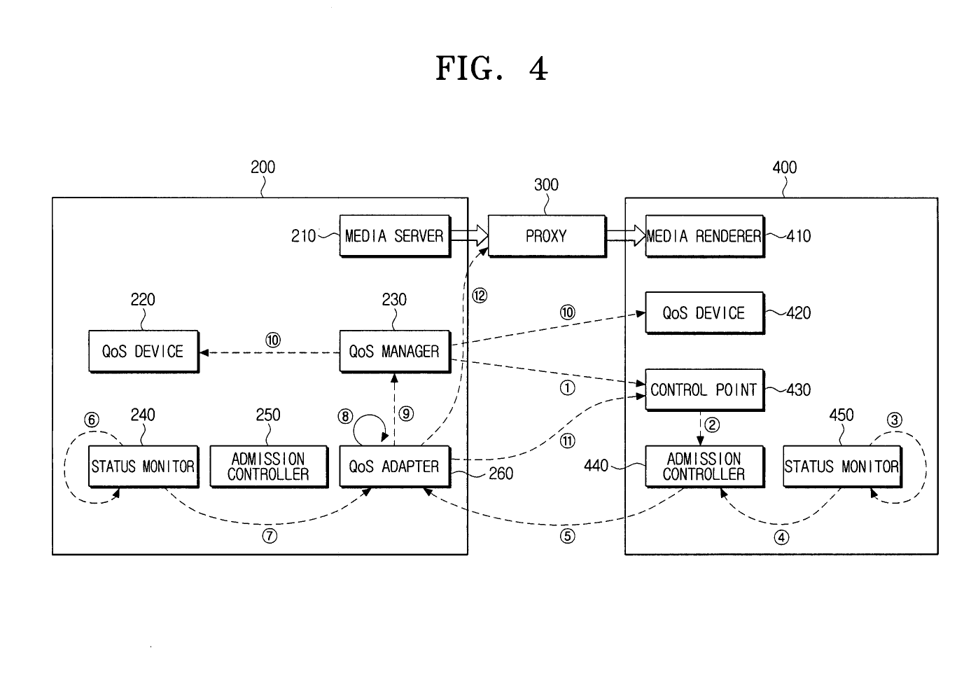

FIG. 4 shows a process for providing streaming services adaptive to the network environment changes according to the protocol stack proposed in FIG. 2, when the QoS preparation process for streaming services fails.

In FIG. 4, if resources changes occur to an extent that current services are affected, the QoS manager 230 notifies the control point 430 that the service request is rejected \textcircled{1}. Then, the control point 430 requests the admission controller 440 to provide adaptive services \textcircled{2}, and the status monitor 450 monitors resources environment on the side of the media receiver 400 \textcircled{3}, and provides the admission controller 440 with resources information \textcircled{4}.

Then, the admission controller 440 requests the QoS adapter 260 to provide adaptive services \textcircled{5}, and the status monitor 240 on the side of the media transmitter 200 monitors resource environment of the network to which it belongs \textcircled{6}, and provides the QoS adapter 260 with resource information \textcircled{7}. The QoS adapter 260 determines a level of the adaptive services with reference to respective resources information \textcircled{8}, and requests the QoS manager 230 to provide resources allocation \textcircled{9}.

The QoS manager 260 allocates the requested resources to the QoS device 220 on the side of the media transmitter 200 and the QoS device 420 on the side of the media receiver 400 \textcircled{10}. At this time, the QoS adapter 260 notifies the control point that the adaptive service request is accepted \textcircled{11}, and the adaptive services start with adapted streams sent from the media server 210 to the media renderer 410 through the proxy 300 \textcircled{12}.

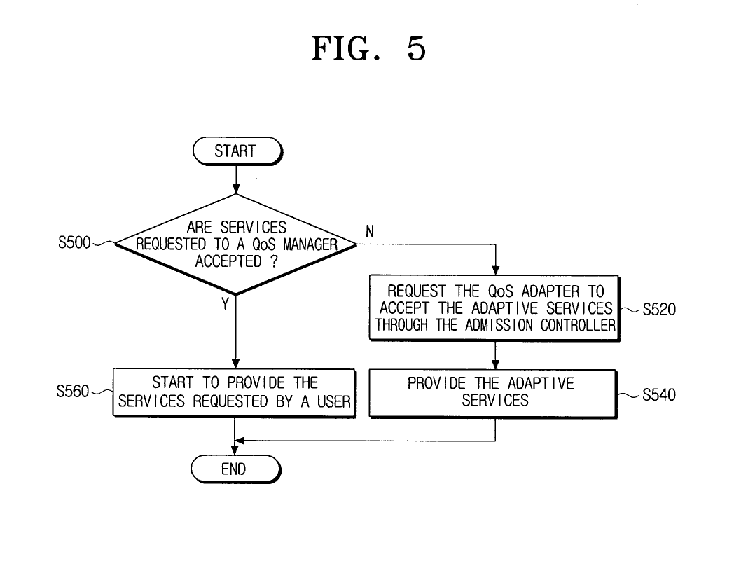

FIG. 5 is a flow chart illustrating a streaming service providing method adaptive to the UPnP QoS architecture according to an exemplary embodiment of the present invention.

In FIG. 5, first, if the QoS manager 230 accepts the request to provide services (Y-S500), the services requested by a user start to be provided (S560). On the other hand, if the QoS manager 230 does not accept the request to provide services, the QoS adapter 260 is requested by the admission controller 250 and 450 to provide the adaptive services (S520). Then, the adaptive services are provided depending on whether the QoS adapter 260 accepts the request to provide the adaptive services (S540).

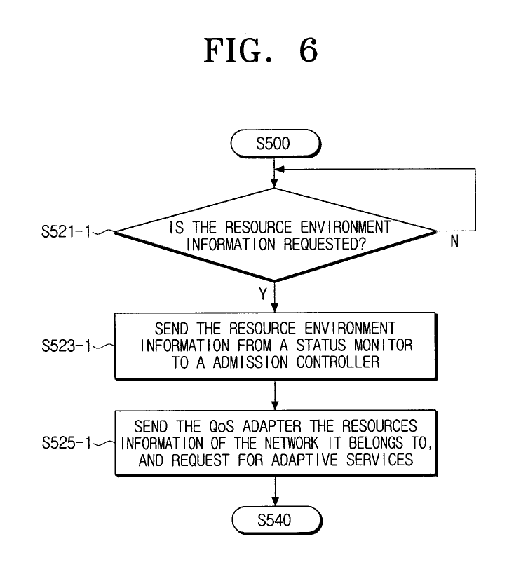

FIG. 6 is a flow chart illustrating a process for sending resources information in the process of providing streaming services of FIG. 3.

In FIG. 6, if the QoS manager does not accept the request to provide services (S500), and there is a request to provide resource environment information (S521-1), the resources environment information is sent from the status monitors 240 and 450 to the admission controllers 250 and 440 (S523-1), and the resources information of a network to which it belongs is sent to the QoS adapter 260 and the adaptive services are requested (S525-1).

That is, the status monitor 240 on the side of the media transmitter 200 sends the resources information to the QoS adapter 260 through the admission controller 250, and the status monitor 450 on the side of the media receiver 400 sends the resources information to the QoS adapter 260 through the admission controller 440.

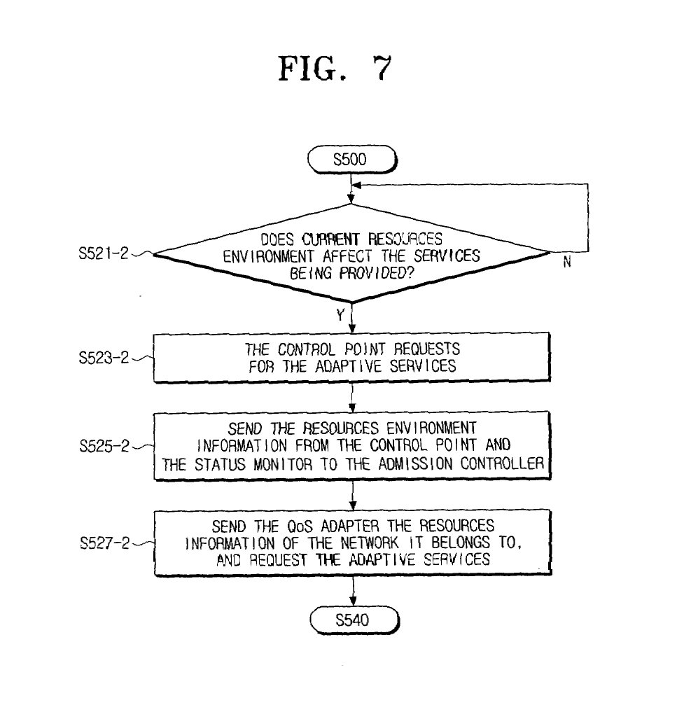

FIG. 7 is a flow chart illustrating a process for sending resources information in the process of providing streaming services of FIG. 4.

In FIG. 7, if the QoS manager does not accept the request to provide services (S500), it is determined whether the current resources environment affects the services being provided (S521-2). If it determined that the current resources environment affects the services being provided, the control point 430 requests adaptive services to be provided (S523-2), and resources environment information is sent from the status monitors 240 and 450 to the admission controllers 250 and 440 (S525-2). Then, the resources information of the network to which it belongs is sent to the QoS adapter 260 and the adaptive services are requested (S527-2).

That is, the status monitor 240 on the side of the media transmitter 200 sends resources information to the QoS adapter 260 through the admission controller 250, and the status monitor 450 sends the resources information to the QoS adapter 260 through the admission controller 440 according to the adaptive service request of the control point 430 on the side of the media receiver 400.

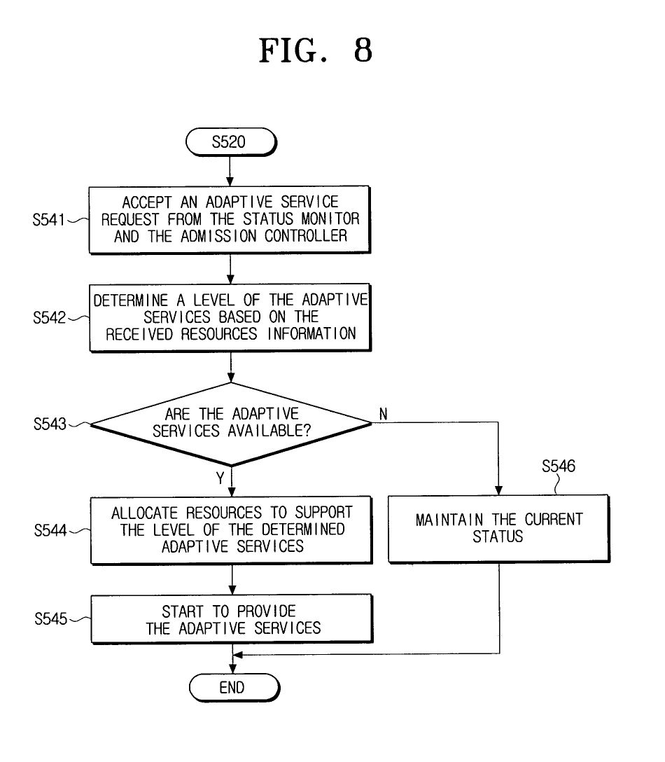

FIG. 8 is a flow chart illustrating a process for providing adaptive services of the QoS adapter in FIGS. 3 and 4.

In FIG. 8, first, if the QoS adapter 260 is requested to provide adaptive service by the admission controller 440 (S520), the QoS adapter 260 accepts the request to provide the adaptive service from the status monitors 240 and 450 and the admission controllers 250 and 440 (S541). Then, the QoS adapter 260 determines a level of the adaptive services based on the received resources information (S542). At this time, through the status monitor 240 in case of the media server 210 and through the status monitor 450 and the admission controller 440 in case of the media renderer 410, the QoS adapter 260 is requested to provide the adaptive services.

In case of the media renderer 410, the QoS adapter 260 is requested to provide the adaptive services by the admission controller 440 only if a preparation process of the QoS requested by a user for media streams fails, and, otherwise, the adaptive services are requested by the status monitor 450.

It is decided whether the adaptive services can be provided (S543), and, if the adaptive services cannot be provided, the streaming services being currently provided are maintained as they are without changes. That is, a service rejection message is delivered to the user, and the services being currently provided continue (S546).

On the contrary, if the adaptive services can be provided, resources are allocated in order for the determined level of the adaptive services to be supported (S544). That is, depending on the state of the available bandwidth in the network, a data transmission rate or an amount of data to be transmitted are adjusted.

For example, if the media streams has a format of MPEG-2 Transport Stream (TS), frames are forced to be dropped to reduce the amount of network resources needed for media stream transmissions. That is, if the currently available resources are more than 20 Mbps, the original streams are sent as they are, if the currently available resources are less than 20 Mbps and more than 11 Mbps, B frames are dropped to provide the adaptive services, and if the currently available resources are less than 11 Mbps and more than 6 Mbps, B and P frames are dropped to provide the adaptive services (S545). Through the processes described above, it is possible to provide the services adaptive to the network resources environment.

As described above, the present invention can overcome the limitations of the related art UPnP architecture, and thus support services adaptive to the changing network resources environment, thereby providing streaming services the quality of which is guaranteed.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A streaming service providing method comprising:
requesting a quality of service (QoS) adapter to provide adaptive services if a QoS manager, which allocates network resources among QoS devices processing media streams, does not accept a request to provide the adaptive services, wherein the QoS adapter determines a level of the adaptive services supportable by a network; and
providing the adaptive services to the network.

2. The method as claimed in claim 1, wherein the requesting the QoS adapter to provide adaptive services comprises:
receiving resource environment information from a status monitor which monitors the network resources environment information, if there is a request for the network resources environment information; and
sending the resource environment information to the QoS adapter and requesting the QoS adapter to provide the adaptive services.

3. The method as claimed in claim 1, wherein the requesting the QoS adapter to provide adaptive services comprises:
requesting the adaptive services by a control point which defines performance of contents transmissions of the network, if it is determined that a network resources environment affects service being currently provided;
receiving resources environment information from the status monitor which monitors the network resources environment information; and
sending the resources environment information to the QoS adapter and requesting the QoS adapter to provide the adaptive services.

4. The method as claimed in claim 2, wherein the providing the adaptive services to the network comprises:
determining a level of the adaptive services depending on the resources environment information;
allocating resources for supporting the level of the adaptive services which is determined; and
providing the adaptive services depending on the allocated resources.

5. The method as claimed in claim 3, wherein the providing the adaptive services to the network comprises:
determining a level of the adaptive services depending on the resources environment information;
allocating resources for supporting the level of the adaptive services which is determined; and
providing the adaptive services depending on the allocated resources.

6. The method as claimed in claim 4, wherein, while streaming services are provided from a Universal Plug and Play (UpnP) media server to a UPnP media renderer, the status monitor monitors network environments of the UPnP media server and the UPnP media renderer, and, if the status monitor detects resources changes to an extent that the streaming services are affected, the status monitor requests the QoS adapter to provide the adaptive services.

7. The method as claimed in claim 5, wherein, while streaming services are provided from a Universal Plug and Play (UpnP) media server to a UPnP media renderer, the status monitor monitors network environments of the UPnP media server and the UPnP media renderer, and, if the status monitor detects resources changes to an extent that the streaming services are affected, the status monitor requests the QoS adapter to provide the adaptive services.

8. The method as claimed in claim 4, wherein the resource environment information is bandwidth status information available in the network.

9. The method as claimed in claim 5, wherein the resource environment information is bandwidth status information available in the network.

10. The method as claimed in claim 8, wherein the determining the level of the adaptive services depending on the resource environment information comprises adjusting a transmission rate depending on the bandwidth status information.

11. The method as claimed in claim 9, wherein the determining the level of the adaptive services depending on the resource environment information comprises adjusting a transmission rate depending on the bandwidth status information.

12. The method as claimed in claim 8, wherein the determining the level of the adaptive services depending on the resource environment information comprises adjusting an amount of data depending on the bandwidth status information.

13. The method as claimed in claim 9, wherein the determining the level of the adaptive services depending on the resource environment information comprises adjusting an amount of data depending on the bandwidth status information.
